(19) United States
(12) Patent Application Publication
(10) Pub. No.: US 2025/0376071 A1
(43) Pub. Date: Dec. 11, 2025

(54) SYSTEM AND METHOD FOR CONTROLLING A VEHICLE ELECTRIC MACHINE IN AN ENVIRONMENTAL CONSERVATION AREA

(71) Applicant: Ford Global Technologies, LLC, Dearborn, MI (US)

(72) Inventors: Matthew Penne, Pierce, NE (US); Jonathan Hair, Northville, MI (US)

(21) Appl. No.: 18/737,308

(22) Filed: Jun. 7, 2024

(51) Int. Cl. B60L 58/12; B60L 7/10; B60L 58/25

(52) U.S. Cl. CPC B60L 58/12; B60L 7/10; B60L 58/25; B60L 2240/421; B60L 2240/423; B60L 2240/545; B60L 2240/547; B60L 2240/549; B60L 2240/62; B60L 2240/66

(57) ABSTRACT

A vehicle includes a battery pack, an electric machine, and a control system including one or more controllers. The control system is configured to discharge power using the electric machine to increase operation loss of the electric machine based on a setting obtained from a current reference setting, a drive input, and a desired surplus loss limit in response to detecting an environmental conservation condition.

### TECHNICAL FIELD

The present disclosure is generally directed to controlling an electrified vehicle having an electric machine, and more specifically for determining current commands for an electric machine.

### BACKGROUND

Electrified vehicles (EV), such as fully electric, hybrid, and fuel cell vehicles, include electric drive systems for propulsion. An electric drive system may include an electric machine that operates as a motor to provide positive torque to a driveline and as a generator to produce electric power for charging a battery pack of the electrified vehicle, which may occur during a regenerative braking operation to slow the EV.

### SUMMARY

In one form, the present disclosure is directed to a vehicle including a battery pack, an electric machine; and a control system including one or more controllers. The control system is configured to discharge power using the electric machine to increase operation loss of the electric machine based on a setting obtained from a current reference setting, a drive input, and a desired surplus loss limit in response to detecting an environmental conservation condition.

In one form, the present disclosure is directed to a method for controlling a vehicle having an electric machine and a battery pack. The method includes charging the battery pack using the electric machine during a regenerative braking operation in response to detecting an environmental conservation condition. The method further includes discharging power using the electric machine based on a setting obtained from a current reference setting, a drive input, and a desired surplus loss limit in response to detecting the environmental conservation condition and an energy level of the battery pack satisfying an energy level condition.

In one form, the present disclosure is directed to a control system for an electrified vehicle (EV) having a battery pack and an electric machine. The control system includes one or more controllers configured to discharge power from the battery pack using the electric machine based on a surplus current reference (SCR) setting detected from a loss-current correlation associating a current reference setting with a drive input and a desired surplus loss limit in response to detecting an environmental conservation condition and an energy level of the battery pack satisfying an energy level condition.

### BRIEF DESCRIPTION OF THE DRAWINGS

FIG. 1 is an example of an EV having an environmental conservation control in accordance with the present disclosure;

FIG. 2 is a block diagram of the environmental conservation control in accordance with the present disclosure;

FIG. 3 is an example of a loss-current correlation model in accordance with the present disclosure; and

FIG. 4 is a flowchart of an environmental conservation routine in accordance with the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The environmental condition of an area in which a vehicle is travelling may be susceptible to poor air quality. For example, many cities have high density traffic, and worse air pollution than rural areas having less traffic. Exhaust from fumes can account for 7% of particulate matter pollution, while brake dust can account for roughly 20%. While electrified vehicles may have regenerative braking for slowing the vehicle, EVs are not immune to emitting brake dust, and since an EV generally weighs more than an internal combustion engine vehicle, the EV can potentially emit more particulate matter pollution.

In some instances, such as city driving, the EV can potentially have a maximum state of charge (SOC). In immediate stop and go traffic, the EV may not be able to use customary regenerative braking due to high battery SOC, causing the EV to rely on friction brake pads causing more particulate matter pollution.

In one form, the present disclosure is generally directed to a system and/or method for an EV that discharges power using an electric machine to increase operation loss of the electric machine based on a surplus current reference (SCR) setting in response to detecting an environmental conservation condition. In one form, the SCR setting is detected from a loss-current correlation associating a current reference setting with a drive input and a desired surplus loss limit. The electric drive system of the EV can be operated inefficiently by increasing a switching frequency of power electronics used for providing current to the electric machine and/or changing current commands to the electric machine. The system and/or method employs an environment conservation control in which regenerative braking is employed to slow the EV, and the electric machine is controlled to consume additional energy than a nominal operation such that an energy level of a battery pack of the EV can be charged during regenerative breaking, thus permitting regenerative braking in the environmental conservation area.

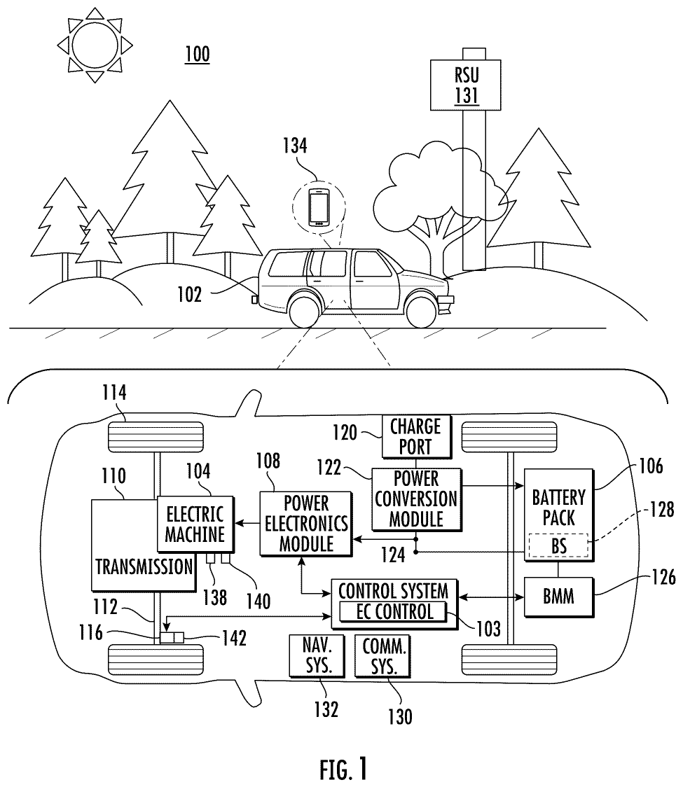

Referring to FIG. 1, an environmental condition of an area 100 that an electrified vehicle (EV) 102 is traveling through may be monitored to preserve or reduce pollutants. The EV 102 is configured to include an environmental conservation (EC) control 103 to facilitate conservation of the air quality, as detailed herein.

In one form, the EV 102 includes a powertrain system having one or more electric machines 104 (e.g., electric motor)), a battery pack 106, and a power electronics module 108. The EV 102 of the present disclosure does not include an engine, and thus, the battery pack 106 provides all of the propulsion power. In other variations, the present disclosure may be applied to other types of EVs such as a hybrid electric vehicle (plug-in or non-plug-in) having an engine, fuel cell electric vehicles (FCEV), and therefore, is not limited to pure battery powered EVs. In addition, the EV is not limited to four-wheel automobiles and may apply to scooters, three-wheel vehicles, and/or among other vehicles.

The electric machine 104 provides power movement of the EV 102, and in a non-limiting example, is mechanically connected to a transmission 110 that is mechanically connected to a drive shaft 112, which is mechanically connected to wheels 114 of the EV 102. In addition to providing propulsion power, the electric machine 104 may be configured to operate as a generator to recover energy that may normally be lost as heat in a friction braking system having a brake pad 116.

More particularly, the electric machine 104 is operated to perform a regenerative braking operation during which the wheels 114 turn the electric machine 104 in an opposite direction using resistance. The electric machine 104 acts like a generator to recover part of the kinetic energy to charge battery cells of the battery pack 106, as the remaining energy is employed by the brake system to generate friction to slow and/or stop the EV 102.

The battery pack 106 provides a high-voltage (HV) direct current (DC) output that is employed to power the electric machine 104 via the power electronics module 108. In one form, the power electronics module 108, which may include an inverter, provides a bi-directionally transfer energy between the battery pack 106 and the electric machine 104. Specifically, as known, the power electronics module 108 converts the DC voltage to a three-phase AC current to operate the electric machine 104, and in a regenerative mode, the power electronics module 108 converts three-phase AC current from the electric machine 104, which is acting as a generator, to DC voltage compatible with the battery pack 106.

In some variations, the battery pack 106 is rechargeable by an external power source (e.g., the grid) via an electric vehicle supply equipment (EVSE) that is electrically connected to a charge port 120 of the EV 102. In some forms, the EV 102 may further include a power conversion module 122 that is an on-board charger having a DC/DC converter to condition power supplied from the EVSE and provide the proper voltage and current levels to the battery pack 106.

In one form, the EV 102 includes a control system 124, which may also be referred to as a “vehicle controller,” to coordinate the operation of the various components. The control system 124 includes electronics, software, or both, to perform the necessary control functions for operating the EV 102. The control system 124 may be a combination vehicle control system and powertrain control module (VSC/PCM). Although the control system 124 is shown as a single device, the control system 124 may include multiple controllers in the form of multiple hardware devices, or multiple software controllers with one or more hardware devices. In this regard, a reference to a “controller” herein may refer to one or more controllers.

As the powertrain control module, the control system 124 is configured to control the electric machine 104 as a motor to propel the EV 102 or generator using the power electronics module 108. In one form, the control system 124 is configured to define current reference settings or, stated differently current command, for the electric machine, where the current reference setting provides a direct or flux current (Id) and a quadrature or torque current (Iq). During non-environmental conservation conditions, the control system 124 is configured to define Id/Iq so as to minimize electric drive system losses.

The control system 124 is also configured to control a braking operation by employing the brake pads 116 and/or performing a regenerative braking operation using the electric machine 104 to reduce the speed of the EV 102. The frictional force for slowing the EV 102 may be provided by the brake pads 116 or the electric machine 104.

In one form, the EV 102 includes a battery management module (BMM) 126 configured to estimate one or more operating characteristics indicative of an energy level of the battery pack 106, such as but not limited to: current, voltage, state of charge (SOC), power limits, and/or open circuit voltage. The BMM 126 is in communication with one or more battery sensors (BS) 128 (e.g., voltage sensor, current sensor, temperature sensor) provided in the battery pack 106 to detect at least some of the operating characteristics.

The EV 102 includes other devices/systems for performing other tasks outside of propelling the EV 102. In a non-limiting example, the EV 102 includes a communication system 130 configured to communicate with devices/servers external of the EV 102, such as, but not limited to a roadside unit (RSU) 131, using wireless communication established using cellular communication, WI-FI, BLUETOOTH, and/or among other communication techniques. The roadside unit 131 may provide information regarding the area 100 in which the EV 102 is traveling through, such as, but not limited, environmental conditions (e.g., air quality index and/or temperature), traffic information, commercial establishments in the area 100. Accordingly, among other components, the communication system 130 includes at least one of a telematics control unit configured to establish vehicle-to-everything (V2X) communication, global navigation satellite system (GNSS), and/or BLUETOOTH module having a BLUETOOTH transceiver.

In one form, the EV 102 may also include a navigation system 132 configured to track a location of the EV 102 and define a travel route based on the desired destination. In a non-limiting example, the navigation system 132 includes a GNSS receiver for detecting a position/location of the EV 102 and a map library configured to store map data employed to define routes and obtain information related to the area 100 in which the EV 102 is driving through.

In some variations, the navigation system 132 is supported by a portable computing device (PCD) 134 provided in the EV 102, in lieu of or in addition to a separate dedicated navigation system 134 installed within the EV 102. Specifically, the PCD is configured to include one or more route guidance software applications that the passenger may employ to go to a desired destination. With the PCD 134 is in communication with the EV 102 via the communication system 130. Accordingly, the navigation system 132 may be supported and implemented by the PCD 134.

Among other components, the navigation system 132 includes a GNSS receiver for detecting a position/location of the AV, a route planning module (RPM) 144 configured to define the route and monitor the travel of the AV, and a map library 146 configured to store map data employed by the RPM 144 in defining a route.

The EV 102 also includes one or more sensors throughout the EV 102 to detect various characteristics in and/or around the EV 102. In a non-limiting example, the sensors include one or more temperature sensors 138 that detect the temperature around the electric machine 104, a torque sensor 140 that is configured to measure a torque of the electric machine 104, and a speed sensor 142 for measuring rotational speed of the wheel 114.

The control system 124 is configured to include the EC control 103 to detect an environmental conservation condition of the environment outside of the EV 102, and if detected, control the electric machine 104 to employ regenerative braking in lieu of friction braking via the brake pads 116 when appropriate to reduce or inhibit emission of friction brake byproduct, such as brake dust. In addition, the control system 124 is configured to control the electric machine 104 based on a surplus current reference (SCR) setting to increase operation loss of the electric machine 104 and support regenerative braking by having the energy level of the battery pack satisfy an energy level condition (e.g., SOC being less than or equal to 50%).

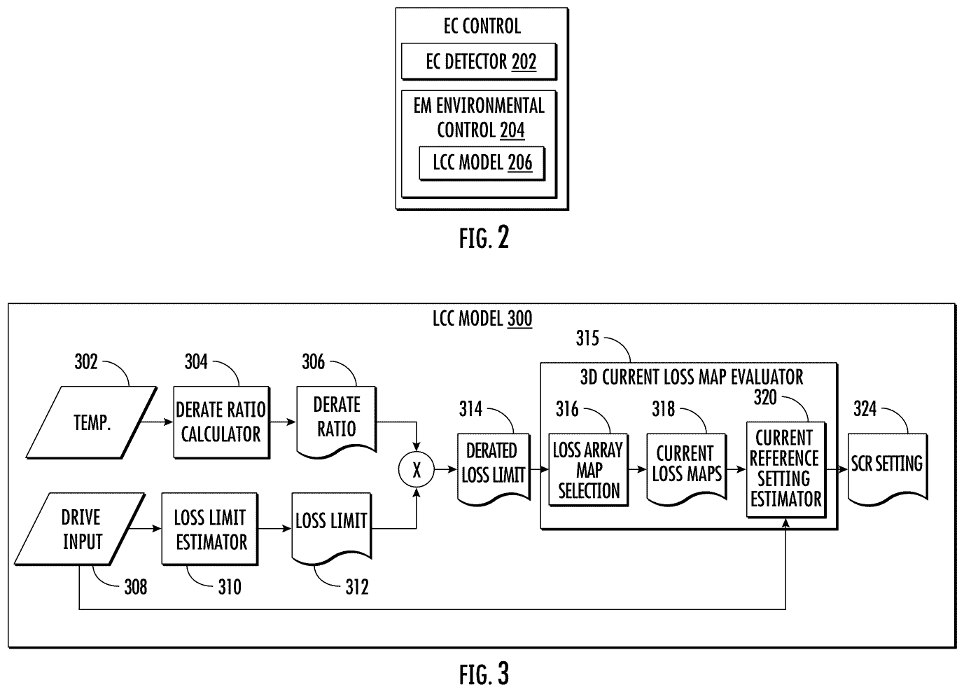

Referring to FIG. 2, in one form, the EC control 103 includes an EC detector 202 and an electric machine (EM) environmental control 204 having a loss-current correlation model (LCC) 206.

The EC detector 202 is configured to detect whether the environment outside of the EV 102 is an EC condition, which may occur in areas in which the air quality is preserved or monitored to reduce air pollutants. In a non-limiting example, the EC detector 202 may detect the EC condition when an air quality index (AQI) of the area 100 is at greater than or equal to a selected level and/or when the area 100 is associated with a conservation area such as, but not limited to a geofence residential area or nature reserves.

In one form, a predefined AQI chart can be used to set the selected level. For example, the EC condition is detected when the AQI is greater than or equal to 100 or when the AQI is one of orange (unhealthy for sensitive groups), red (unhealthy), purple (very unhealthy), or maroon (hazardous). The AQI may be received from external systems such as, but not limited to, the RSU 131 or the PCD 134 in communication with the EV 102. While specific values/categories of the AQI is provided, other suitable AQI charts may be employed for setting the selected level for initiating EC control.

In one form, a conservation area is detected based a vehicle location, which may be provided by the navigation system 132 and/or a location of a restrictive area detected by, for example, map data identifying conservation areas and/or a message from a system monitoring the conservation area (e.g., a geofence system). In a non-limiting example, the EC detector 202 is configured to identify certain areas, such as nature reserves and national parks, as conservation areas which may be detected using the map data. In another example, when the EV 102 travel through a geofence, a system that controls the geofence is configured to detect the EV 102 and transmits a message to the EV 102 identifying the geofenced area and perhaps if the area has any restriction. In some forms, the EC detector 202 is configured to detect the geofenced area as a conservation area in response to the area being a residential area and/or the message indicating that the area is conservation type-area.

When an EC condition is detected, the EM environmental control 204 is configured to priorities regenerative braking over friction braking with braking pad 116 when slowing and/or stopping the EV 102, so as to inhibit or reduce emission of braking particulates. In addition, to using regenerative braking, the EM environmental control 204 is configured to control the EM using a SCR setting during drive operations of the electric machine 104 to increase the amount of power drawn from the battery pack 106 such that the energy level of the battery pack 106 is less with the use of an environmental conservation than without the use of environmental conservation. By using more power moving the EV 102, regenerative braking may continue to be used to slow the EV 102.

In one form, the SCR setting is detected using the LCC model 206 associating a current reference setting with a drive input and a desired surplus loss limit. More particularly, referring to FIG. 3, an example of a LCC model 300 is provided and can be used as the LCC model 206. IN one form, the LCC model 206, 300 may be implemented in one or more software programs executable by a computing device and includes predefined information such as various correlation data and/or algorithms, as described herein.

The model 300 obtains one or more temperature measurements 302 of at least one of ambient temperature around the electric machine 104, cooling fluid provided to the electric machine 104, ambient temperature about the EV 102, among other temperature measurements that can indicate operating condition of the electric machine 104.

A derate ratio calculator 304 uses the temperature 302 to estimate a derate ratio 306 that is employed to adjust the current reference settings for the electric machine 104 based on the operating condition. Specifically, the derate ratio 306 adjusts the current reference settings to provide a controlled loss of the electric machine 104 to account possible stresses on the drive system. In one form, the derate ratio calculator 304 may be provided as a look-up table that associates temperature values with predefined derate ratios. In another form, the derate ratio calculator 306 is provided as one or more algorithms that uses the temperature 302 as variable input to determine the derate ratio 306.

In some variations, if multiple temperature measurements 302 are obtained, the derate ratio calculator 304 determines the derate ratio 306 using the highest temperature measurement 302. In some variations, if multiple temperature measurements 302 are provided, the derate ratio calculator 304 estimates the derate ratio 306 for each temperature measurement. With multiple derate ratios 306, the derate ratio calculator 304 may be configured to select the highest derate ratio 306 or, alternatively, take an average of the derate ratios 306. While specific examples are provided for determining the derate ratio 306 using temperature 302, other methods may be used and are within the scope of the present disclosure.

In addition to the temperature 302, the LCC model 300 obtains drive inputs 308 that are employed to obtain a loss limit 312 using the loss limit estimator 310. The loss limit 312 is a recommended amount of loss of the electric machine 104 to meet the demand of the EV 102. In one form, the drive inputs 308 include torque of the electric machine 104 and normalized speed. In one form, the loss limit estimator 310 associates various torque and normalized speed values with a loss limit 312, and may be provided as one or more look-up tables.

Using the derate ratio 306 and the loss limit 312, a derated loss limit 314 is calculated. for example, the derated loss limit 314 is equal to the derate ratio 306 multiplied by the loss limit 312.

In one form, the LCC model 300 employs a three-dimensional (3D) loss map evaluator 315 for defining the SCR setting 324 based on the derated loss limit 314. Specifically, the evaluator 315 stores at least one current loss map for each loss limit among a plurality of loss limits. Each current loss map defines current reference settings, which may also be referred to as current commands (settings for Id/Iq), for different combinations of torque and normalized speed. The evaluator 315 selects at least one current loss map based on the derated loss limit 314 and then uses the drive inputs to obtain the SCR setting 324.

Specifically, a loss array map selector 316 is configured to select one or more current loss maps 318 based on the derated loss limit 314. Specifically, the loss array map selector 316 is configured to store a plurality of current loss maps (e.g., Id/Iq maps) for different loss levels. The loss maps indicate the amount of additional loss over a standard loss with a maximum torque per ampere (MTPA) calibration. For example, with an MTPA=50 Nm and normalized speed of 10 RPM/V, the standard calibration loss is 1070 W, and with the with environmental conservation condition, there would be an additional loss on top of the standard calibration loss.

The loss array map selector 316 is configured to select one or more current loss maps 320 based on the derate loss limit 314. Specifically, if there is no current loss map with the specific derate loss limit 314, the loss array map selector 316 selects a current loss map for a derate loss limit that is higher than the derate loss limit 314, which is referred to as a high loss map, and a current loss map for a derate loss that is lower than the derate loss limit 314, which is referred to as a low loss map.

A current reference setting estimator 320 is configured to determine the SCR setting 324, which is indicative of the Id and Iq commands for the electric machine 104 to obtain the desired derated loss limit. If there is one current loss map, the current reference setting estimator 320 selects the SCR setting 324 associated with the drive inputs 308. Alternatively, if there are high and low loss maps, the current reference setting estimator 320 is configured to define the SCR setting 324 using a high SCR setting associated with a high loss limit (e.g., a high surplus loss limit) from the high loss map and a low SCR setting associated with a low loss limit (e.g., a low surplus loss limit) from the low loss map.

The current reference setting estimator 320 is configured to interpolate the upper SCR setting associated and the lower SCR setting based on a relationship of the desired surplus loss limit, the upper surplus loss limit, and the lower surplus loss limit to obtain the SCR setting 324. In a non-limiting example, with the derated loss limit (DLL) being 2000 W, the current loss maps for a high loss limit (LL_{HIGH})=3000 and low loss limit (LL_{LOW})=1000 W are used to obtain the SCR setting 324. The low SCR setting from the low loss map is provided as Id_{lOW}=−100 and Iq_{LOW}=100 A, and the high SCR setting from the high loss map is provided as Id_{HIGH}=−200 A and Iq_{HIGH}=200 A. Equations 1 and 2 are example interpolation equation used for determining current commends for the SCR setting 324. The SCR setting 324 are employed to operate the electric machine 104 and provide surplus loss of the electric machine 104 during the environment conservation condition.

$${Id}_{SCR} = \frac{{Id}_{HIGH} - {Id}_{LOW}}{{LL}_{HIGH} - {LL}_{LOW}} \times \frac{DLL - {LL}_{LOW}}{{LL}_{HIGH} - {LL}_{LOW}} + {Id}_{low} \qquad Equation 1$$

$${Iq}_{SCR} = \frac{{Iq}_{HIGH} - {Iq}_{LOW}}{{LL}_{HIGH} - {LL}_{LOW}} \times \frac{DLL - {LL}_{LOW}}{{LL}_{HIGH} - {LL}_{LOW}} + {Iq}_{low} \qquad Equation 2$$

The LCC model 206 may be configured to include additional operations, such as but not limited to having a slew control to reduce or inhibit jumps in current. In one form, the LCC model 206 is integrated as part of a standard EM control in which loss array map selection may employ either the derated loss limit 314 or an unconditioned loss command for selecting the loss maps.

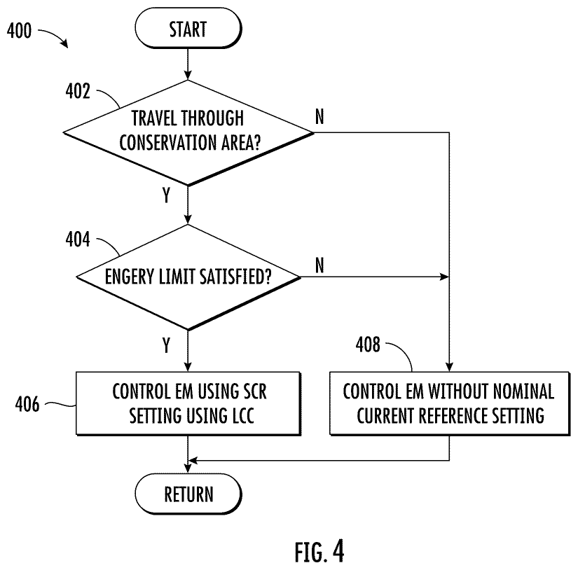

Referring to FIG. 4, an example environmental conservation routine 400 is executed by the control system 124. At operation 402, the control system 124 determines if the EV 102 is traveling through a conservation area based on, for example, AQI, a vehicle location, and/or a restrictive, as provided above.

If traveling through a conservation area, the control system 124 determines if the energy limit of the battery pack 106 satisfies an energy state condition. In a non-limiting example, the control system 124 determines if the SOC of the battery pack 106 is greater than or equal to a charge threshold (e.g., energy state condition). The charge threshold is indicative of a SOC value that is low (e.g., 20%) and that energy drawn from the battery pack 1106 should be nominal.

If the energy limit satisfies the energy state condition (e.g., SOC is greater than or equal to 20%), the control system 124 controls the electric machine 104 using the SCR setting that is determined based on the LCC model 206, at operation 406, as detailed above. Alternatively, if the energy limit does not meet the energy state condition (e.g., SOC is less than 20%), the control system 124 controls the electric machine using nominal current reference settings and without an additional loss, at operation 408. For example, the control system 124 determines current reference setting using the drive inputs and a loss command dependent on the drive inputs.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

In this application, the term “module” and/or “controller” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory or memory device is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A vehicle comprising:
a battery pack;
an electric machine; and
a control system including one or more controllers, the control system configured to discharge power using the electric machine to increase operation loss of the electric machine based on a setting obtained from a current reference setting, a drive input, and a desired surplus loss limit in response to detecting an environmental conservation condition.

2. The vehicle of claim 1, wherein the drive input includes at least one of a normalized speed and a torque.

3. The vehicle of claim 1, wherein the environmental conservation condition is detected using at least one of an air quality index, a vehicle location, or a location of a restrictive area relative to a vehicle travel route.

4. The vehicle of claim 1, wherein the control system is configured to discharge power based on the setting in further response to an energy level of the battery pack satisfying an energy level condition, wherein energy level is a state of charge of the battery pack.

5. The vehicle of claim 1, wherein the desired surplus loss limit is defined based on a derate loss ratio and a temperature measurement.

6. The vehicle of claim 1, wherein:
the setting is obtained using a loss-current correlation that associates the current reference setting with the drive input and the desired surplus loss, and
the loss-current correlation is configured to define the setting using a high surplus current reference (SCR) setting associated with a high surplus loss limit and a low SCR setting associated with a low surplus loss limit, the desired surplus loss limit falls between the high surplus loss limit and the low surplus loss limit.

7. The vehicle of claim 6, wherein the setting is an interpolation of the high SCR setting and the low SCR setting.

8. The vehicle of claim 1, further comprising a power electronic system including an inverter to control power to the electric machine in accordance with the setting.

9. A method for controlling a vehicle having an electric machine and a battery pack, comprising:
charging the battery pack using the electric machine during a regenerative braking operation in response to detecting an environmental conservation condition; and
discharging power using the electric machine based on a setting obtained from a current reference setting, a drive input, and a desired surplus loss limit in response to detecting the environmental conservation condition and an energy level of the battery pack satisfying an energy level condition.

10. The method of claim 9, wherein the drive input includes at least one of a normalized speed and a torque.

11. The method of claim 9, wherein the environmental conservation condition is detected using at least one of an air quality index, a vehicle location, or a location of a restrictive area relative to a vehicle travel route.

12. The method of claim 9, wherein the energy level is a state of charge of the battery pack.

13. The method of claim 9, further comprising defining the desired surplus loss limit based on a derate loss ratio and on a temperature measurement.

14. The method of claim 9, wherein the loss-current correlation is configured to define the SCR setting using a high SCR setting associated with a high surplus loss limit and a low SCR setting associated with a low surplus loss limit, the desired surplus loss limit falls between the high surplus loss limit and the low surplus loss limit.

15. The method of claim 14, further comprising interpolating the high SCR setting and the low SCR setting to obtain the SCR setting.

16. A control system for an electrified vehicle (EV) having a battery pack and an electric machine, comprising:
one or more controllers configured to discharge power from the battery pack using the electric machine based on a surplus current reference (SCR) setting obtained from a loss-current correlation associating a current reference setting with a drive input and a desired surplus loss limit in response to detecting an environmental conservation condition and an energy level of the battery pack satisfying an energy level condition.

17. The control system of claim 16, wherein the drive input includes at least one of a normalized speed and a torque.

18. The control system of claim 16, wherein the environmental conservation condition is detected using at least one of an air quality index, a vehicle location, or a location of a restrictive area relative to a vehicle travel route.

19. The control system of claim 16, wherein the loss-current correlation is configured to define the SCR setting using a high SCR setting associated with a high surplus loss limit and a low SCR setting associated with a low surplus loss limit, the desired surplus loss limit falls between the high surplus loss limit and the low surplus loss limit.

20. The control system of claim 19, wherein the SCR setting is an interpolation of the high SCR setting and the low SCR setting.
